(19) United States
(12) Patent Application Publication
(10) Pub. No.: US 2016/0174299 A1
(43) Pub. Date: Jun. 16, 2016

(54) RADIANT HEATER FOR A COOKTOP

(71) Applicant: EIKA, S. COOP., Etxebarria (ES)

(72) Inventors: Daniel DE LOS TOYOS LOPEZ, Eibar (ES); Jon Endika AZPIRITXAGA ZALBIDE, Durango (ES)

(21) Appl. No.: 14/959,305

(22) Filed: Dec. 4, 2015

(30) Foreign Application Priority Data
Dec. 11, 2014 (ES) 201431610

(51) Int. Cl. H05B 6/06; F24C 15/10; H05B 6/12

(52) U.S. Cl. CPC H05B 6/062; H05B 6/12; F24C 15/102; H05B 2213/07

(57) ABSTRACT

According to one implementation a radiant heater is provided that includes a cover, an insulating base arranged on the cover, at least one resistance element fixed to the insulating base, a temperature sensor suitable for measuring the temperature of a cooktop arranged on the radiant heater, and a flat resilient member suitable for keeping the temperature sensor in constant contact with the cooktop in a final assembly position.

### CROSS-REFERENCE TO RELATED APPLICATIONS

This application relates to and claims the benefit and priority to Spanish Application No. 201431610, filed Dec. 11, 2014.

### TECHNICAL FIELD

The present invention relates to a radiant heater for a cooktop. Particularly, it relates to a radiant heater including a sensor suitable for measuring the temperature of the cooktop, which may be a vitroceramic cooktop.

### BACKGROUND

Cooking apparatus are known comprising radiant heaters adapted to a cooktop, which include temperature sensors the objective of which is to measure the temperature of the glass ceramic stovetop through which the temperature of the cookware that is arranged on the corresponding radiant heater can be controlled. For example, possible fires due to oil overheating in the cookware, forgetting the cookware on the radiant heater in operation can thereby be prevented, and/or the cooking of the food can also be controlled at all times as the temperature thereof is directly controlled.

Patent document GB 1,569,588 discloses a cooking apparatus comprising a radiant heater comprising a sensor element extending to the glass ceramic stovetop. The sensor element is arranged inside a tubular body going through an insulating base of the radiant heater on which the resistance of the radiant heater is arranged in a fixed manner.

Patent document EP 2626638 A1 discloses a cooking apparatus comprising a radiant heater comprising a sensor element making contact with the lower surface of the glass ceramic stovetop, a spring supported at one end in the radiant heater whereas the other end presses the temperature element against the glass ceramic stovetop. The elastic force with which a part the spring presses the sensor element against the glass ceramic stovetop is less than the elastic force with which the spring presses the radiant heater towards the glass ceramic stovetop.

### SUMMARY OF THE DISCLOSURE

According to one implementation a radiant heater is provided that comprises a metal cover, an insulating base arranged on the cover, at least one resistance fixed to the insulating base, a temperature sensor suitable for measuring the temperature of the cooktop, and elastic means suitable for keeping the temperature sensor in permanent contact with the cooktop in a final assembly position.

The elastic means comprises a flat fixed to the cover at one end, the temperature sensor, according to some implementations, being fixed to the flat. In the final assembly position, the flat is arranged in a tensed manner forming an angle with the cover such that it pushes the temperature sensor against the cooktop. It thereby maintains the temperature sensor pressed against the cooktop, maintaining constant contact between both, such that the temperature sensor is able to measure the temperature of the cooktop at all times. It is understood that the temperature of the cooktop and the temperature of cookware arranged on the radiant heater are generally very similar. Therefore, in addition to preventing possible accidents due to very hot oils, forgetting to switch off the radiant heater, etc., the cooking of the food can be controlled continuously.

These and other advantages and features will become evident in view of the drawings and detailed description.

### BRIEF DESCRIPTION OF THE DRAWINGS

FIG. 1 shows a plan view of a radiant heater according one embodiment.

FIG. 2 is a perspective view of the radiant heater shown in FIG. 1.

FIG. 3 shows a cross-section according to section line III-III of the radiant heater shown in FIG. 1, before the assembly thereof in a cooking apparatus.

FIG. 4 shows the cross-section according to section line III-III of the radiant heater shown in FIG. 1, in the final assembly position below the cooktop.

FIG. 5 shows in detail a temperature sensor comprised in the radiant heater shown in FIG. 1.

### DETAILED DESCRIPTION

FIGS. 1 to 4 show a radiant heater 1 arranged below a cooktop 2, such as a glass ceramic cooktop. According to one embodiment the radiant heater comprises a metal cover 3, a cylindrical insulating base 4 made of a thermally and electrically insulating material and arranged housed inside the cover 3, and at least one resistance element 5 disposed on the insulating base 4. The cover 3 may have a circular cookware shape, the insulating base 4 being arranged such that it is supported on a bottom 3b of the cover 3.

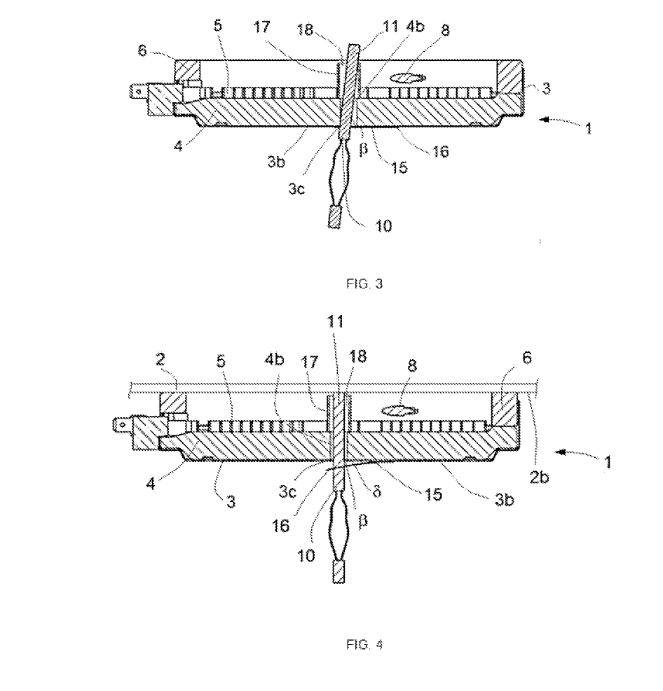

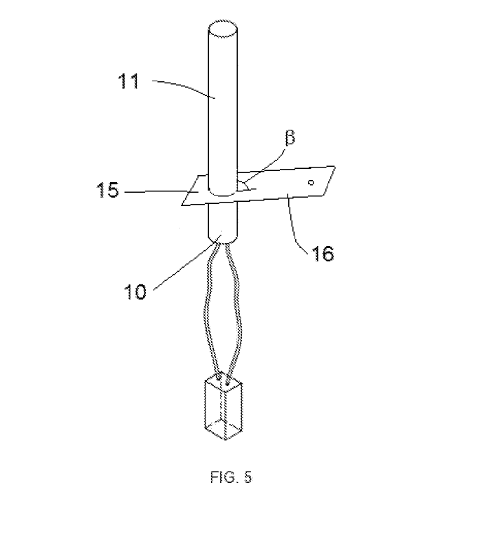

The radiant heater 1 may further comprise an insulating ring 6, supported on the insulating base 4 and housed at least partially in the cover 3. The insulating ring 6 makes contact with an inner surface 2b of the cooktop 2 in a final assembly position shown in detail in FIG. 4. In other non-depicted embodiments, the insulating ring 6 and the insulating base 4 can form a single piece.

The radiant heater 1 further comprises a temperature sensor 10 that extends axially through the radiant heater 1. When the radiant heater 1 is assembled in the corresponding cooking apparatus in the final assembly position, the temperature sensor 10 is arranged in contact with the lower surface 2b of the glass ceramic stovetop 2 as shown in FIG. 4. According to one implementation the temperature sensor 10 is an RTD (resistance temperature detector) sensor.

The radiant heater 1 further comprises elastic means 15 that maintains the temperature sensor 10 in constant contact with the cooktop 2. The elastic means 15 comprises a flat 16 that is arranged such that it is fixed to the cover 3 at one end. For example, it may be arranged such that it is fixed to the bottom 3c of the cover 3. The flat 16 may be fixed to the cover 3 by the uses of one or more screws, or by any of a variety of other methods. The flat 16 has a free end that is not fixed to the cover 3.

According to one implementation a body 11 of the temperature sensor 10 passes through and is fixed to the flat 16. The temperature sensor 10 can be fixed to the flat 16 by any known method, such as welding, adhesives, plastic strain of the body 11, or other known mechanical means. The temperature sensor 10 is arranged passing through the cover 3 and the insulating base 4. According to other implementations the temperature sensor 10 may be fixed to a side of the flat 16 rather than passing through the flat.

According to one embodiment the radiant heater 1 comprises a support 17 that is arranged such that it is supported on the insulating base 4. In the embodiment shown in the drawings, the support 17 is arranged such that it is centered with respect to the insulating base 4. The support 17 has a first hole 18 that is arranged vertical or substantially vertical. The hole 18 having a central axis that is orthogonal, or substantially orthogonal to the cooktop surface when the cooktop 2 and heater 1 are assembled together. Prior to the cooktop 2 being assembled on the heater 1, the temperature sensor 10 projects from the support 17 as illustrated in FIG. 3.

According to one embodiment the temperature sensor 10 is arranged such that it is fixed to the flat 16 forming an acute angle β with same. The body 11 of the temperature sensor 10 is then introduced in the radiant heater 1 through respective holes 3c, 4b and 18 of the cover 3, of the insulating base 4 and of the support 17, respectively, as shown in FIGS. 3 and 4. The elastic means 15 is then fixed to the cover 3 so that the flat 16 is arranged parallel, or substantially parallel, to the bottom 3c of the cover 3, as shown in FIG. 3. The size of the holes 3c, 4b and 18 permitting the temperature sensor 10 to maintain the angle β with respect to the bottom 3c of the cover 3. As shown in FIG. 3, after the elastic means 15 is assembled on the heater 1, the temperature sensor 10 projects beyond the insulating ring 6, so that end of the temperature sensor 10 makes contact with the cooktop 2 before the cooktop 2 makes contact with the insulating ring 6.

It is important to note that although the radiant heater 1 has been described as including a cover 3, other embodiments are contemplated that do not include a cover. For example, the mechanical integrity of the insulating base 4 may be such that no cover is necessary.

In a final assembly position, shown in detail in FIG. 4, the temperature sensor 10 is arranged orthogonal, or substantially orthogonal to the cooktop 2, making contact with the inner surface 2b of the cooktop 2. The manner by which the temperature sensor 10 is coupled to the radiant heater 1 results in the body 11 of the temperature senor 10 being straightened when the cooktop 2 is placed onto the radiant heater 1. (See comparison of FIG. 4 with FIG. 3.) As the temperature sensor 10 straightens to assume the orthogonal, or substantially orthogonal position, the free end of the flat 16 bends with respect the cover 3. In the final assembly position with the cooktop 2 arranged on the insulating ring 6, the free end of the flat 16 is arranged in a tensed manner forming an angle δ with the cover 3 such that it pushes the temperature sensor 10 against the inner surface 2b of the cooktop 2 as shown in FIG. 4. According to one embodiment the angle δ formed by the flat 16 with the cover 3 and the angle β formed by the temperature sensor 10 with the flat 16 are complementary or substantially complementary angles in that they add up to 90° or substantially 90°.

In the final assembly position, the end of the temperature sensor 10 makes contact with the inner surface 2b of the cooktop 2. The flat 16 applies a force on the temperature sensor 10, pushing it towards the cooktop 2 such that it assures a constant contact between the end of the temperature sensor 10 with the cooktop 2.

The radiant heater 1 may also comprise a temperature-limiting device 7 connected to the resistance element 5 and to a non-depicted control device of the radiant heater 1. In such an embodiment the temperature-limiting device 7 may comprise a second temperature sensor 8, such as of the dilatable rod or tube-type, that passes through the insulating ring 6 and extends over the insulating base 4 above the resistance element 5. An insulating support 9 is fixed to the outside of the wall 3b of the cover 3 by known fixing means. The insulating support 9 houses disconnect means (not shown in the figures) connected to the second temperature sensor 8. The second temperature sensor 8 is arranged between the resistance element 5 and the cooktop 2.

Each radiant heater 1 has an established maximum temperature that cannot be exceeded during operation to prevent potential damage to the cooktop 2, and to prolong its service life, the objective of the temperature-limiting device 7 being to limit the maximum or borderline temperature that can be reached by the radiant heater 1 when it has been operating for some time. Furthermore, the temperature-limiting device 7 has an established reset temperature, the reset temperature being a pre-established temperature that allows resetting the disconnect means, after which the temperature-limiting device 7 is deactivated.

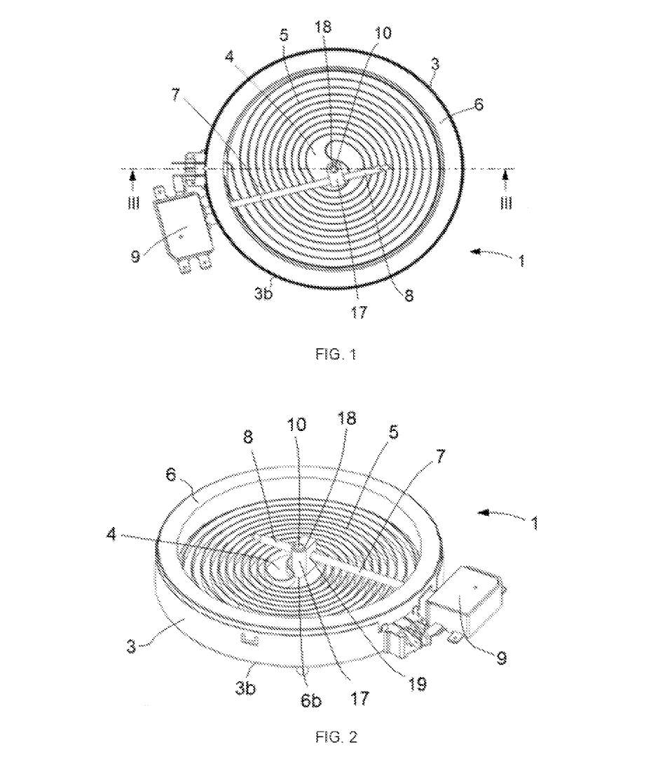

In an embodiment that includes a second temperature sensor 8, the support 17 may further comprise a second hole 19, as shown in FIG. 2, through which the second temperature sensor 8 passes. According to one embodiment the first hole 18 and the second hole 19 of the support 17 are arranged orthogonal, or substantially orthogonal, to one another. In the embodiment shown in the drawings, the second temperature sensor 8 does pass across the entire radiant heater 1 with one end being supported by the support 17, as seen in FIG. 1.

In addition to having a function of housing the temperature sensor 10, and in some instances a second temperature sensor 8, the support 17 can also function to protect the temperature sensors against infrared radiation emitted by the radiant element 5, thereby protecting the temperature sensors from receiving direct infrared radiation, which would entail a mistaken reading of the temperature of the cookware arranged above the cooktop 2.

According to one embodiment the support 17 is made of a thermally and electrically insulating material, such as, for example, a ceramic material. According to other embodiments the support 17 may be made of vermiculite, steatite, cordierite or any other material known for these functions.

1. A radiant heater for a cooktop, the radiant heater comprising:
a housing structure having a top side and a bottom side, the housing structure having a longitudinal first opening with a first central axis and extending between and through the top side and bottom side, the first opening having a first cross-sectional area,
a resistance element arranged in the housing structure,
a flat having a first end portion and a second end portion, the first end portion being fixed to the bottom side of the housing structure, the second end portion being elastic and extending from the first end portion with an ability to be flexed outward from the bottom side of the housing structure so as to form a first angle with the bottom side, in a rest position the second end portion of the flat is substantially parallel with the bottom side of the housing structure, in an active position the second end portion of the flat forms the first angle with the bottom side of the housing structure and is resiliently urged toward the rest position,
a first temperature sensor having a body that extends through the first opening, the body having a second cross-sectional area less than the first cross-sectional area, the body having a first part that is coupled with the second end portion of the flat and a second part that extends above the top side of the housing structure, the first temperature sensor moveable in an axial direction within the first opening upon the second end portion of the flat transitioning between the rest and active positions.

2. The radiant heater according to claim 1, wherein a longitudinal portion of the body of the first temperature sensor that moves within the first opening has a central axis that forms a second angle with the second end portion of the flat.

3. The radiant heater according to claim 2, wherein the first and second angles are substantially complementary angles.

4. The radiant heater according to claim 1, wherein the second end portion of the flat comprises a second opening through which the body of the first temperature sensor passes.

5. The radiant heater according to claim 1, wherein the housing structure comprises a cover and an insulating base arranged on the cover, the resistance element being coupled to the insulating base, the first opening extending through the cover and insulating base, the bottom side of the housing structure corresponding to a bottom side of the cover.

6. The radiant heater according to claim 1, further comprising a support arranged in the housing structure, the support comprising a second opening that is substantially centered with respect to the first central axis, a part of the body of the first temperature sensor extending through the second opening, the support comprising a material that protects the first temperature sensor from infrared radiation.

7. The radiant heater according to claim 1, wherein a part of the body of the first temperature sensor extending through the first opening has a second central axis, the second central axis being more axially aligned with the first central axis of the first opening when the second end portion of the flat is in the active position as opposed to when the second end portion of the flat is in the rest position.

8. The radiant heater according to claim 6, further comprising a second temperature sensor arranged substantially orthogonal to the first temperature sensor, the support bearing an end portion of the second temperature sensor, the second temperature sensor forming a part of a temperature-limiting device of the radiant heater.

9. The radiant heater according to claim 8, wherein the support includes a third opening through which the end portion of the second temperature sensor passes, the second and third openings being arranged substantially orthogonal to one another.

10. A radiant heater for a cooktop, the radiant heater comprising:
a cover,
an insulating base arranged on the cover,
at least one resistance element coupled to the insulating base,
a first temperature sensor suitable for measuring the temperature of the cooktop when the cooktop is assembled on the radiant heater; and
elastic means suitable for keeping the temperature sensor in constant contact with the cooktop when the cooktop is assembled on the radiant heater, the elastic means comprise a flat fixed to the cover at one end, the temperature sensor being fixed to the flat, the flat moveable between a rest position wherein it is arranged substantially parallel to a bottom side of the cover and an active position wherein it forms an angle with the bottom side of the cover, in the active position the flat is resiliently urged toward the rest position so that when the cooktop is assembled on the radiant heater the flat pushes the temperature sensor against the cooktop.

11. The radiant heater according to claim 10, wherein the first temperature sensor is fixed to the flat forming a first angle with the flat.

12. The radiant heater according to claim 11, wherein the flat forms a second angle with the bottom side of the cover, the first angle and second angle being substantially complementary angles when the cooktop is assembled on the radiant heater.

13. The radiant heater according to claim 10, wherein the temperature sensor passes through openings within the cover and the insulating base.

14. The radiant heater according claim 10, further comprising a support which is arranged such that it is supported on the insulating base, centered with respect to the insulating base and comprising a first opening through which the first temperature sensor passes, the support comprising a material to protect the temperature sensor from infrared radiation.

15. The radiant heater according to claim 14, further comprising a second temperature sensor having an end portion that is also supported by the support, the second temperature sensor arranged substantially orthogonal to the first temperature sensor.

16. The radiant heater according to claim 15, wherein the support includes a second opening through which the end portion of the second temperature sensor passes, the first and second openings being arranged substantially orthogonal to one another.

17. A method of assembling a cooktop on a radiant heater so that a temperature sensor associated with the radiant heater makes constant contact with the cooktop when the cooktop is assembled on the radiant heater, the radiant heater comprising a resistance element located within a housing structure, when assembled on the radiant heater the cooktop lies above the resistance element and rests on a top surface of a support, the housing structure having a first through opening of a first cross-sectional area for receiving a body of the temperature sensor having a second cross-sectional area less than the first cross-sectional area, the first through opening extending through a bottom side of the housing structure, the method comprising:
obtaining a flat resilient member having a first end portion and a second end portion,
fixing the temperature sensor to the second end portion of the flat resilient member,
placing the temperature sensor into the first through opening through the bottom side of the housing structure,
fixing the first end portion of the flat resilient member to the bottom side of the housing structure so that the second end portion of the flat resilient member is substantially parallel to the bottom side of the housing structure, the temperature sensor having a length such that at least a portion of temperature sensor extends above the top surface of the support when the second end portion of the resilient member is arranged substantially parallel to the bottom side surface of the housing structure,
positioning the cooktop to rest on the top surface of the support so that the cooktop applies a downward force on the temperature sensor to cause the second end portion of the resilient member to flex downward while at the same time urging the temperature sensor upward against the bottom surface of the cooktop.

18. A method according to claim 17, wherein the temperature sensor is fixed to the second end portion of the flat resilient member forming a first angle with the second end portion.

19. A method according to claim 17, wherein the second end portion of the flat resilient member comprises a through opening, the method including inserting at least a portion of the temperature sensor into the through opening prior to fixing the temperature sensor to the second end portion of the flat resilient member.

20. A method according to claim 18, wherein the flat resilient member is configured such that when the cooktop rests on the top surface of the support, the second end portion of the resilient member forms a second angle with the bottom side of the housing structure, the first angle and second angle being substantially complementary angles.
